(19) United States
(12) Patent Application Publication
(10) Pub. No.: US 2009/0266071 A1
(43) Pub. Date: Oct. 29, 2009

(54) Hydraulic Four-Wheel-Drive Working Vehicle

(76) Inventors: Toshifumi YASUDA, Amagaskaki-shi (JP); Norihiro ISHII, Amagaskaki-shi (JP); Yasuhisa MOCHIZUKI, Amagaskaki-shi (JP); Hideki KANENOBU, Amagaskaki-shi (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/430,566

(22) Filed: Apr. 27, 2009

(30) Foreign Application Priority Data
Apr. 28, 2008 (JP) JP 2008-116601

(51) Int. Cl. F16H 39/00

(52) U.S. Cl. 60/484

(57) ABSTRACT

A hydraulic four-wheel-drive working vehicle includes a front/rear differential-lock switch valve. The front/rear differential-lock switch valve fluidly connects forward-movement high-pressure lines of the pair of main operation fluid lines, which are fluidly connected to a main hydraulic motor, and the pair of sub operation fluid lines, which are fluidly connected to a sub hydraulic motor, and also fluidly connects the forward-movement low-pressure lines of the pair of main operation fluid lines and the pair of sub operation fluid lines. The front/rear differential-lock switch valve is capable of taking a throttling fluid-connection state of fluidly connecting the corresponding lines in a state where a throttle is interposed therebetween and a full fluid-connection state of fluidly connecting the corresponding lines in a state where the throttle is not interposed therebetween.

### BACKGROUND OF THE INVENTION

1. Field of the Invention

The present invention relates to a hydraulic four-wheel-drive working vehicle configured so that a pair of main driving wheels and a pair of sub driving wheels, which are arranged on one side and the other side in a vehicle lengthwise direction, respectively, are operatively driven by rotational power from a main hydraulic motor and a sub hydraulic motor, respectively.

2. Related Art

There has been proposed a hydraulic four-wheel-drive working vehicle including a pair of first driving wheels and a pair of second driving wheels arranged on one side and the other side in a vehicle lengthwise direction, respectively, a first hydraulic motor that outputs rotational power for driving the first driving wheels, a second hydraulic motor that outputs rotational power for driving the second driving wheels, first and second hydraulic pumps operatively driven by a driving power source, a pair of first operation fluid lines that fluidly connects the first hydraulic pump and the first hydraulic motor in such a manner that they form a first HST, and a pair of second operation fluid lines that fluidly connects the second hydraulic pump and the second hydraulic motor in such a manner that they form a second HST, wherein a forward-movement high-pressure line of the pair of first operation fluid lines and a forward-movement high-pressure line of the pair of second operation fluid lines are fluidly connected to each other through a high-pressure-side communicating line in which a throttle valve is interposed, and a forward-movement low-pressure line of the pair of first operation fluid lines and a forward-movement low-pressure line of the pair of second operation fluid lines are fluidly connected to each other through a low-pressure-side communicating line in which a throttle valve is interposed (see U.S. Pat. No. 3,641,765).

The high-pressure-side communicating line that fluidly connects forward-movement high-pressure lines of the pair of first operation fluid lines and the pair of second operation fluid lines and the low-pressure-side communicating line that fluidly connects the forward-movement low-pressure lines of the pair of first operation fluid lines and the pair of second operation fluid lines makes it possible to automatically distribute and supply a part of operation fluid, which has been discharged from one of the first and second hydraulic pumps, into the hydraulic motor that forms the HST in cooperation with the other of the first and second hydraulic pumps in accordance with a difference in turning radius between the first and second driving wheels when the vehicle makes a turn so that the conventional working vehicle realizes a front-rear hydraulic differential function (hydraulic center differential function). The throttle valves interposed in the communicating lines make it possible to prevent all of operation fluid, which has been discharged from the first and second hydraulic pumps, from flowing in a concentrated manner into one of the first and second hydraulic motors that drives one of the first and second driving wheels even if the one driving wheel falls into a depression, a mud area or the like so that the rotation load of the one driving wheel becomes extremely small, whereby the conventional working vehicle realizes a differential-lock function.

However, the conventional working vehicle could realize the hydraulic center differential function only in a state of being subjected to load due to the throttle valves when the vehicle travels, since the forward-movement high-pressure lines of the pair of first operation fluid lines and the pair of second operation fluid lines are fluidly connected to each other in a state where the corresponding throttle valve is constantly interposed therebetween, and the forward-movement low-pressure lines of the pair of first operation fluid lines and the pair of second operation lines are fluidly connected to each other in a state where the corresponding throttle valve is constantly interposed therebetween. For this reason, the conventional working vehicle could not bring out the intrinsic performance of the hydraulic motors in an adequate manner, resulting in worsened transmission efficiency.

### SUMMARY OF THE INVENTION

In view of the prior art, it is an object of the present invention to provide a hydraulic four-wheel-drive working vehicle configured so that a main driving wheel and a sub driving wheel arranged on one side and the other side in a vehicle lengthwise direction are operatively driven by a main hydraulic motor and a sub hydraulic motor, respectively, the main hydraulic motor being fluidly connected through a pair of main operation fluid lines to one or plural hydraulic pump operatively driven by a driving power source, and the sub hydraulic motor being fluidly connected to the hydraulic pump through a pair of sub operation fluid lines that are independent from the pair of main operation fluid lines, the working vehicle being capable of selecting driving states in accordance with a condition of a road surface on which the vehicle travels.

In order to achieve the object, the present invention provides a hydraulic four-wheel-drive working vehicle that includes main and sub driving wheels arranged on one and the other sides in a vehicle lengthwise direction, a main hydraulic motor outputting rotational power for driving the main driving wheel, a sub hydraulic motor outputting rotational power for driving the sub driving wheel, one or plural hydraulic pump operatively driven by a driving power source, a pair of main operation fluid lines fluidly connecting the hydraulic pump and the main hydraulic motor in such a manner that they form a main-driving-wheel HST, and a pair of sub operation fluid lines fluidly connecting the hydraulic pump and the sub hydraulic motor in such a manner that they form a sub-driving-wheel HST, the pair of sub operation fluid lines being independent from the pair of main operation fluid lines, wherein the hydraulic four-wheel-drive working vehicle further includes a front/rear differential-lock switch valve that fluidly connects forward-movement high-pressure lines of the pair of main operation fluid lines and the pair of sub operation fluid lines and also fluidly connects the forward-movement low-pressure lines of the pair of main operation fluid lines and the pair of sub operation fluid lines, and wherein the front/rear differential-lock switch valve is configured so as to take a throttling fluid-connection state of fluidly connecting the corresponding lines in a state where a throttle is interposed therebetween and a full fluid-connection state of fluidly connecting the corresponding lines in a state where the throttle is not interposed therebetween.

In the hydraulic four-wheel-drive working vehicle according to the present invention, the forward-movement high-pressure line of the pair of main operation fluid lines fluidly connected to the main hydraulic motor driving the main driving wheel that is one of front and rear wheels is fluidly connected to the forward-movement high-pressure line of the pair of sub operation fluid lines fluidly connected to the sub hydraulic motor driving the sub driving wheel that is the other of front and rear wheels through the front/rear differential-lock switch valve, and the forward-movement low-pressure line of the pair of main operation fluid lines is also fluidly connected to the forward-movement low-pressure line of the pair of sub operation fluid lines through the front/rear differential-lock switch valve. The front/rear differential-lock switch valve is configured so as to take the throttling fluid-connection state of fluidly connecting the corresponding lines in a state where the throttle is interposed therebetween and the full fluid-connection state of fluidly connecting the corresponding lines in a state where the throttle is not interposed therebetween. The thus configured hydraulic four-wheel-drive working vehicle makes it possible to realize a front-rear hydraulic differential function without involving loss of transmission efficiency by setting the front/rear differential-lock switch at the full fluid-connection state in a case where the working vehicle travels on a normal road surface, and also makes it possible to effectively prevent the working vehicle from being incapable of traveling while realizing the front-rear hydraulic differential function by setting the front/rear differential-lock switch at the throttling fluid-connection state in a case where the working vehicle travels on a slippery road surface or one of the front and rear wheels falls into a depression, a mud area or the like.

Preferably, the working vehicle may further include a 2-wheel-drive/4-wheel-drive switch valve interposed in the pair of sub operation fluid lines so as to divide the pair of sub operation fluid lines into pump-side lines and motor-side lines, the 2-wheel-drive/4-wheel-drive switch valve being positioned on a side closer to the sub hydraulic motor than a connecting point at which the pair of sub operation fluid lines are fluidly connected to the pair of main operation fluid lines through the front/rear differential-lock switch valve, and capable of selectively taking an open state or a closed state.

The 2-wheel-drive/4-wheel-drive switch valve fluidly connects the corresponding pump-side lines and the motor-side lines of the pair of sub operation fluid lines at the open state, and closes the pump-side lines and fluidly connects one motor-side line and the other motor-side line of the pair of sub operation fluid lines at the closed state.

More preferably, the front/rear differential-lock switch valve is set at the full fluid-connection state at the time when the 2-wheel-drive/4-wheel-drive switch valve is at the closed state.

### BRIEF DESCRIPTION OF THE DRAWINGS

The above, and other objects, features and advantages of the present invention will become apparent from the detailed description thereof in conjunction with the accompanying drawings wherein.

FIG. 1 is a side view of a hydraulic four-wheel-drive working vehicle according to a first embodiment of the present invention.

FIG. 2 is a hydraulic circuit diagram on a hydraulic pump side of the working vehicle shown in FIG. 1.

FIG. 3 is a hydraulic circuit diagram on a hydraulic motor side of the working vehicle shown in FIG. 1.

FIG. 4 is a vertical cross-sectional view of a wheel motor device of the working vehicle shown in FIG. 1, the wheel motor device driving a front wheel functioning as a sub driving wheel.

FIG. 5 is a partial vertical cross-sectional view of the front wheel side of the working vehicle shown in FIG. 1.

FIG. 6 is a hydraulic circuit diagram on a hydraulic motor side of a hydraulic four-wheel-drive working vehicle according to a second embodiment of the present invention.

FIG. 7 is a vertical cross-sectional side view of a first modified example of a wheel motor device capable of being applied to the hydraulic four-wheel-drive working vehicle according to the first and second embodiments.

FIG. 8 is a horizontal cross-sectional plan view taken along line VIII-VIII of FIG. 7.

FIG. 9 is a vertical cross-sectional side view of a second modified example of the wheel motor device.

FIG. 10 is a horizontal cross-sectional plan view taken along line X-X of FIG. 9.

### DETAILED DESCRIPTION OF THE PREFERRED EMBODIMENTS

### First Embodiment

A preferred embodiment of the present invention will now be described with reference to the accompanying drawings.

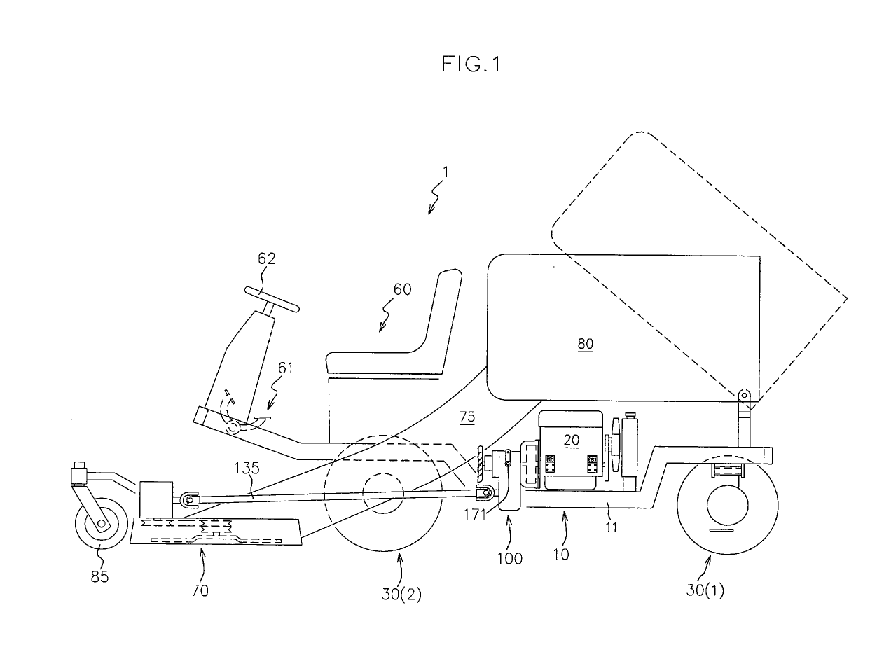

FIG. 1 is a side view of a hydraulic four-wheel-drive working vehicle 1 according to a first embodiment of the present invention.

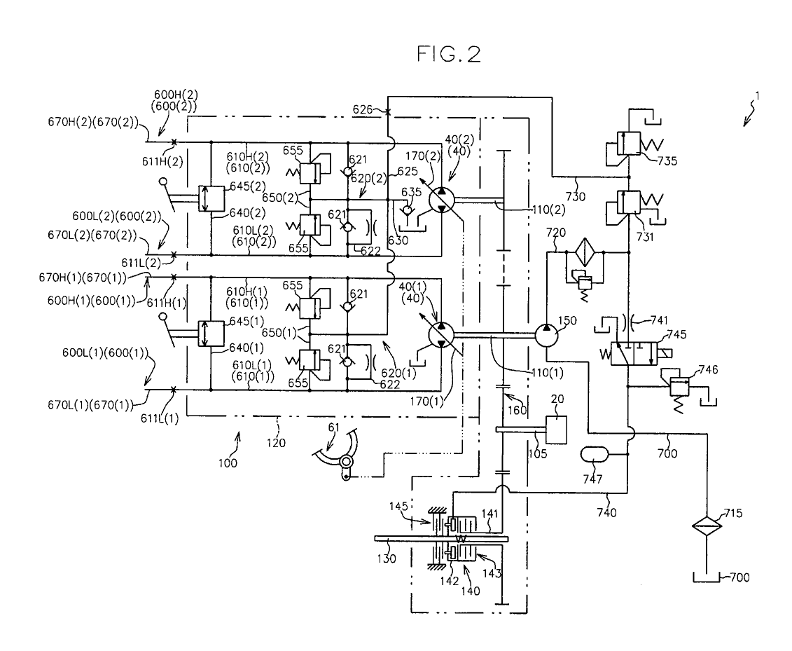

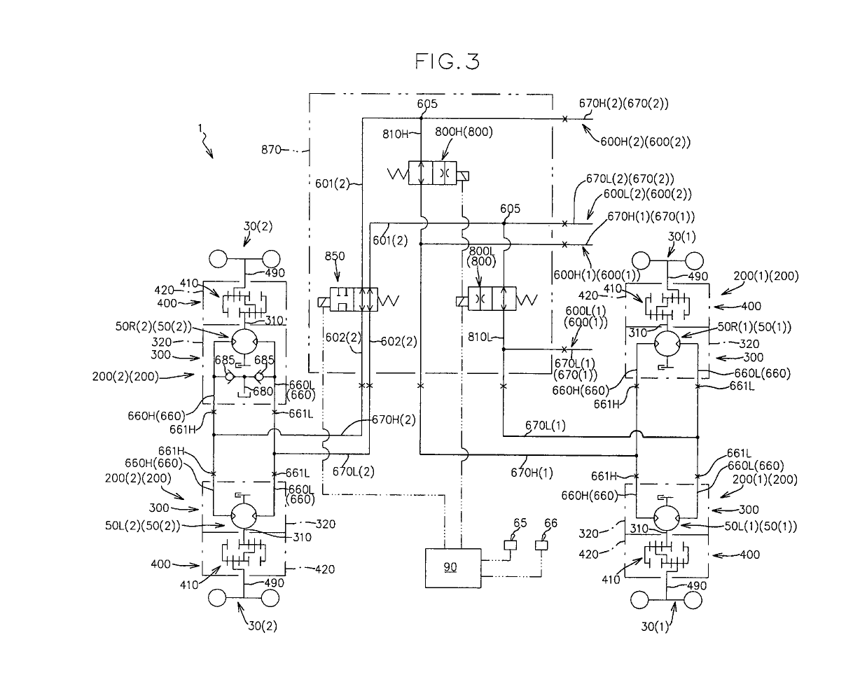

FIGS. 2 and 3 are hydraulic circuit diagrams of the working vehicle 1.

The working vehicle is of a hydraulic four-wheel-drive type configured so that main driving wheels 30(1) and sub driving wheels 30(2) arranged on one and the other sides in a vehicle lengthwise direction are operatively driven by rotational power from a main hydraulic pump 50(1) and a sub hydraulic motor 50(2), respectively.

Specifically, as shown in FIGS. 1 and 2, the working vehicle 1 includes a vehicle frame 10, a driving power source 20 supported by the vehicle frame 10, the main driving wheels 30(1) (rear wheels in the present embodiment) and the sub driving wheels 30(2) (front wheels in the present embodiment), the main hydraulic motor 50(1) outputting rotational power for driving the main driving wheels 30(1), the sub hydraulic motor 50(2) outputting rotational power for driving the sub driving wheels 30(2), one or plural hydraulic pump 40 operatively driven by the driving power source 20, a pair of main operation fluid lines 600(1) fluidly connecting the hydraulic pump 40 and the main hydraulic motor 50(1) in such a manner that they form a main-driving-wheel HST, and a pair of sub operation fluid lines 600(2) fluidly connecting the hydraulic pump 40 and the sub hydraulic motor 50(2) in such a manner that they form a sub-driving-wheel HST, the pair of sub operation fluid lines 600(2) being independent from the pair of main operation fluid lines 600(1).

In the present embodiment, the working vehicle 1 is embodied by a riding lawn mower.

Accordingly, the working vehicle 1 includes, in addition to the above components, a driver's seat 60 supported by the vehicle frame 10, a mower device 70, a grass collector 80 for storing grasses which have been cut by the mower device 70, and a duct 75 defining a conveying path in which grasses cut by the mower device 70 are conveyed.

In the present embodiment, the mower device 70 is arranged on a front side of the front wheels, therefore the working vehicle 1 is further provided with a caster wheel 85 arranged on a front side of the mower device 70.

The working vehicle 1 according to the present embodiment includes a main hydraulic pump 40(1) and a sub hydraulic pump 40(2) as the hydraulic pump 40, as shown in FIG. 2.

Specifically, the main hydraulic pump 40(1) is fluidly connected to the main hydraulic motor 50(1) through the pair of main operation fluid lines 600(1) so as to form the main-driving-wheel HST, and the sub hydraulic pump 40(2) is fluidly connected to the sub hydraulic motor 50(2) through the pair of sub operation fluid lines 600(2) so as to form the sub-driving-wheel HST.

In place of the configuration, the working vehicle 1 could include a single hydraulic pump that has a pair of first ports functioning as suction ports at a forward movement of the vehicle and a pair of second ports functioning as discharge ports at a forward movement of the vehicle.

In the alternative configuration, one of the pair of first ports and one of the pair of second ports are fluidly connected to the main hydraulic motor 50(1) through the pair of main operation fluid lines 600(1), and the other of the pair of first ports and the other of the pair of second port are fluidly connected to the sub hydraulic motor 50(2) through the pair of sub operation fluid lines 600(2).

The main hydraulic pump 40(1) and the sub hydraulic pump 40(2) are accommodated in a single pump case 120 in a state of being operatively driven by the single driving power source 20 so as to form a pump unit 100.

Specifically, as shown in FIG. 2, the pump unit 100 includes a main pump shaft 110(1) and a sub pump shaft 110(2) respectively supporting the main and sub hydraulic pump 40(1), 40(2) in a relatively non-rotatable manner with respect thereto in a state of being operatively connected to the driving power source 20, the pump case 120 accommodating the main and sub hydraulic pumps 40(1), 40(2) and supporting the main and sub pump shafts 110(1), 110(2) in a rotatable manner around respective axis lines, a PTO shaft 130 supported by the pump case 120 in a rotatable manner around its axis line in a state of having a first end extended outward from the pump case 120, a PTO clutch mechanism 140 accommodated in the pump case 120 so as to be interposed in a power transmission path extending from the driving power source 20 to the PTO shaft 130, and an auxiliary pump 150 operatively connected to the driving power source 20.

In the present embodiment, the main and sub pump shafts 110(1), 110(2), a driving-side member 141 of the PTO clutch mechanism 140, and the auxiliary pump 150 are operatively connected to the driving power source 20 through an input shaft 105, as shown in FIG. 2.

Specifically, the pump unit 100 includes, in addition to the above components, the input shaft 105 supported by the pump case 120 in a state of being operatively connected to the driving power source 20, a gear transmission mechanism 160 accommodated in the pump case 120 so as to operatively connect the input shaft 105 to the main and sub pump shafts 110(1), 110(2), the auxiliary pump 150, and the driving-side member 141 of the PTO clutch mechanism 140.

In the present embodiment, the auxiliary pump 150 is directly or indirectly driven by one end of the main pump shaft 110(1).

The main and sub hydraulic pumps 40(1), 40(2) have the same configuration to each other. Therefore, the following explanation is made mainly on the main hydraulic pump 40(1), and the same reference numerals or the same reference numerals with replacing the parenthetical reference (1) with (2) are denoted for the same components of the sub hydraulic pump 40(2) as those of the main hydraulic pump to omit the description thereof.

The main hydraulic pump 40(1) includes a pump-side cylinder block (not shown) supported by the corresponding main pump shaft 110(1) in a relatively non-rotatable manner with respect thereto, and plural pump-side pistons (not shown) accommodated in the pump-side cylinder block in a relatively non-rotatable manner but in a relatively reciprocating manner along the axial direction with respect thereto.

At least one of the main hydraulic pump 40(1) and the main hydraulic motor 50(1) is of a variable displacement type so that they form the main-driving-wheel HST in cooperation with each other.

Similarly, at least one of the sub hydraulic pump 40(2) and the sub hydraulic motor 50(2) is of a variable displacement type so that they form the sub-driving-wheel HST in cooperation with each other.

In the present embodiment, the main and sub hydraulic pumps 40(1), 40(2) are of a variable displacement type, as shown in FIG. 2.

Accordingly, the pump unit 100 further includes main and sub output-adjusting mechanisms 170(1), 170(2) that change capacities of the main and sub hydraulic pumps 40(1), 40(2), respectively.

The main output-adjusting mechanism 170(1) includes a main movable swash plate (not shown) capable of being slated around a swing axis line so as to change a reciprocating range of the corresponding pump-side pistons, and a main control shaft 171 (see FIG. 1) supported by the pump case 120 so as to be rotated around its axis line in accordance with operation from outside, the main control shaft 171 slanting the corresponding main movable swash plate around the swing axis line according to the rotation of itself about the axis line.

Similarly, the sub output-adjusting mechanism 170(2) includes a sub movable swash plate and a sub control shaft (not shown).

Both the main and sub movable swash plates are capable of slanting in both forward and rearward directions with a neutral position sandwiched therebetween.

The main and sub control shafts are operated in a synchronized manner to each other through a speed-change operating member 61 such as a speed-change pedal that is arranged in the vicinity of the driver's seat 60 (see FIGS. 1 and 2).

Specifically, in the present embodiment, the main and sub control shafts are operated in a synchronized manner to each other in response to a manual operation on the speed-change operating member 61, whereby the main and sub movable swash plates are tilted in the forward or rearward direction in a synchronized manner to each other.

The pump case 120 that accommodates the main hydraulic pump 40(1), the sub hydraulic pump 40(2) and the PTO clutch mechanism 140 is formed with various fluid channels including a pair of main-pump-side operation fluid channels 610(1) and a pair of sub-pump-side operation fluid channels 610(2) that form parts of the pair of main operation fluid lines 600(1) and the pair of sub operation fluid lines 600(2), respectively.

The main-pump-side operation fluid channels 610(1) include a main-pump-side forward-movement high-pressure fluid channel 610H(1) and a main-pump-side forward-movement low-pressure fluid channel 610L(1) that have a high pressure and a low pressure, respectively, at the forward movement of the vehicle.

The main-pump-side forward-movement high-pressure fluid channel 610H(1) has a first end fluidly connected to a forward-movement discharge side of the main hydraulic pump 40(1) and a second end opened to an outer surface to form a main-pump-side forward-movement high-pressure port 611H(1).

The main-pump-side forward-movement low-pressure fluid channel 610L(1) has a first end fluidly connected to a forward-movement suction side of the main hydraulic pump 40(1) and a second end opened to the outer surface to form a main-pump-side forward-movement low-pressure port 611L(1).

The sub-pump-side operation fluid channels 610(2) include a sub-pump-side forward-movement high-pressure fluid channel 610H(2) and a sub-pump-side forward-movement low-pressure fluid channel 610L(2) that have a high pressure and a low pressure, respectively, at the forward movement of the vehicle.

The sub-pump-side forward-movement high-pressure fluid channel 610H(2) has a first end fluidly connected to a forward-movement discharge side of the sub hydraulic pump 40(2) and a second end opened to the outer surface to form a sub-pump-side forward-movement high-pressure port 611H(2).

The sub-pump-side forward-movement low-pressure fluid channel 610L(2) has a first end fluidly connected to a forward-movement suction side of the sub hydraulic pump 40(2) and a second end opened to the outer surface to form a sub-pump-side forward-movement low-pressure port 611L(2).

The pump case 120 is further formed with a main-pump-side charge fluid channel 620(1) for replenishing the pair of main operation fluid lines 600(1) with operation fluid, and a sub-pump-side charge fluid channel 620(2) for replenishing the pair of sub operation fluid lines 600(2) with operation fluid, as shown in FIG. 2.

The main-pump-side charge fluid channel 620(1) has a first end fluidly connected to the auxiliary pump 150 functioning as a hydraulic pressure source and a second end fluidly connected to the pair of main-pump-side operation fluid channels 610H(1), 610L(1) through a pair of charge check valves 621, respectively.

Similarly, the sub-pump-side charge fluid channel 620(2) has a first end fluidly connected to the auxiliary pump 150 functioning as the hydraulic pressure source and a second end fluidly connected to the pair of sub-pump-side operation fluid channels 610H(2), 610L(2) through a pair of charge check valves 621, respectively.

In the present embodiment, the main-pump-side and sub-pump-side charge fluid channels 620(1), 620(2) are fluidly connected to the auxiliary pump 150 through a common charge fluid channel 625.

Specifically, as shown in FIG. 2, the pump case 120 is formed with the common charge fluid channel 625 having a first end opened to the outer surface to form a common charge port 626, and the first ends of the main-pump-side and sub-pump-side charge fluid channels 620(1), 620(2) are fluidly connected to the common charge fluid channel 625.

Furthermore, the pump case 120 is formed with a self-suction fluid channel 630, as shown in FIG. 2.

The self-suction fluid channel 630 has a first end opened to an inner space of the pump case 120 and a second end fluidly connected to the first ends of the main-pump-side and sub-pump-side charge fluid channels 620(1), 620(2), as shown in FIG. 2.

A self-suction check valve 635 is interposed in the self-suction fluid channel 630 so as to allow fluid to flow in the self-suction fluid channel 630 from the pump case 120 to the main-pump-side and sub-pump-side charge fluid channels 620(1), 620(2) while preventing a reverse flow.

A self-suction structure including the self-suction fluid channel 630 and the self-suction check valve 635 can effectively prevent an occurrence of a free wheel phenomenon.

Specifically, when the working vehicle is stopped on a slope or the like with the driving power source being stopped, rotational power is applied to a below mentioned motor shafts 310 that are operatively connected to the main and sub driving wheels 30(1), 30(2), so that the main and sub hydraulic motors 50(1), 50(2) supported by the motor shafts 30 make an attempt to exert pumping function.

In this case, if the pair of main operation fluid lines 600(1) fluidly connecting the main hydraulic pump 40(1) and the main hydraulic motor 50(1) and the pair of sub operation fluid lines 600(2) fluidly connecting the sub hydraulic pump 40(2) and the sub hydraulic motor 50(2) are filled with operation fluid, this operation fluid applies a braking force to the main and sub hydraulic motors 50(1), 50(2). However, at the same time, the pumping function of the main and sub hydraulic motors 50(1), 50(2) create higher pressure in one of the main operation fluid lines 600(1) and one of the sub operation fluid lines 600(2), which may cause a leakage of operation fluid from the one operation fluid lines that are subjected to the higher pressure.

In the event of the occurrence of such a leakage of the operation fluid, the fluid is circulated from the operation fluid line that is subjected to the negative pressure to the operation fluid line that is subjected to the higher pressure, which facilitates the leakage of the operation fluid from the operation fluid line that is subjected to the higher pressure. Further, finally, the operation fluid in the pair of main operation fluid lines 600(1) and the pair of sub operation fluid lines 600(2) are exhausted, which causes the main driving wheels 30(1) and the sub driving wheels 30(2) to start freely rotating (the free wheel phenomenon). This may cause the working vehicle to descend the slope.

With regard to this point, the provision of the self-suction fluid channel 630 and the self-suction check valve 635 could cause fluid to be flowed from the internal space in the pump case into the operation fluid line of the pair of main operation fluid lines 600(1) that is subjected to the negative pressure and the operation fluid line of the pair of sub operation fluid lines 600(2) that is subjected to the negative pressure, thereby effectively preventing the occurrence of the free wheel phenomenon.

In the present embodiment, each of the main-pump-side and sub-pump-side charge fluid channels 620(1), 620(2) is provided with a fluid channel 622 that bypasses one of the pair of charge check valves 621 trough an throttle. By providing the fluid channel 622, it is possible to realize a neutral state of the main-driving-wheel HST and the sub-driving-wheel HST, without strictly setting a neutral position of the main and sub output-adjusting mechanisms 170(1), 170(2).

Furthermore, the pump case 120 is provided with a main-pump-side bypass fluid channel 640(1) which fluidly connects the pair of main-pump-side operation fluid channels 610(1) and in which a main-pump-side bypass valve 645(1) capable of being operated from an outside is inserted, and a sub-pump-side bypass fluid channel 640(2) which fluidly connects the pair of sub-pump-side operation fluid channels 610(2) and in which a sub-pump-side bypass valve 645(2) capable of being operated from an outside is inserted, as shown in FIG. 2.

The main-pump-side and sub-pump-side bypass valves 645(1), 645(2) are configured so as to selectively communicate or shut off the corresponding bypass fluid channels 640(1), 640(2).

Furthermore, the pump case 120 is formed with a pair of main-pump-side high-pressure relief fluid channels 650(1) having first ends fluidly connected to the pair of main-pump-side operation fluid channels 610(1), respectively, and second ends opened to a low pressure area, and a pair of sub-pump-side high-pressure relief fluid channels 650(2) having first ends fluidly connected to the pair of sub-pump-side operation fluid channels 610(2), respectively, and second ends opened to the low pressure area.

A relief valve 655 is inserted in each of the pair of main-pump-side high-pressure relief fluid channels 650(1) and the pair of sub-pump-side high-pressure relief fluid channels 650(2) so as to have a primary side fluidly connected to the corresponding pump-side operation fluid channel 610(1), 610(2) and a secondary side fluidly connected to the low pressure area.

In the present embodiment, as shown in FIG. 2, the second ends of the main-pump-side high-pressure relief fluid channels 650(1) are fluidly connected to the main-pump-side charge fluid channel 620(1) on an upstream side than the pair of charge check valves 621 with respect to a flow direction of fluid in the charge fluid channel.

Similarly, the second ends of the sub-pump-side high-pressure relief fluid channels 650(2) are fluidly connected to the sub-pump-side charge fluid channel 620(2) on an upstream side than the pair of charge check valves 621 with respect to a flow direction of fluid in the charge fluid channel.

For example, the pump case 120 may include a pump case main body (not shown) formed with an opening having a size that allows the main and sub hydraulic pumps 40(1), 40(2) to pass therethrough, and a pump-side port block (not shown) detachably connected to the pump case main body so as to liquid-tightly close the opening.

In the configuration, the various fluid channels are preferably formed in the pump-side port block.

The auxiliary pump 150 functions as a charge fluid source for the main-driving-wheel HST and the sub-driving-wheel HST, and also functions as an operation fluid source for the PTO clutch mechanism 140.

The auxiliary pump 150 has a suction side fluidly connected to a fluid source 700 such as an oil tank through a suction line 710 in which a filter 715 is inserted.

The auxiliary pump 150 has a discharge side fluidly connected to a discharge line 720 to which a charge fluid supply line 730 and a PTO operation fluid line 740 are fluidly connected.

Specifically, the charge fluid supply line 730 is fluidly connected to the discharge line 720 through a restrictor valve 731.

That is, the charge fluid supply line 730 has a first end fluidly connected to a secondary side of the restrictor valve 731 and a second end fluidly connected to the common charge port 626.

The charge fluid supply line 730 has a fluid pressure set to a predetermined pressure by the charge relief valve 735.

The PTO operation fluid line 740 is fluidly connected to the discharge line 720 through a throttle 741 on a primary side of the restrictor valve 731.

In the PTO operation fluid line 740, is inserted a PTO switch valve 745 for changing a state of the PTO clutch mechanism between a power transmission state and a power shut-off state.

A PTO relief valve 746 and an accumulator 747 are fluidly connected to the PTO operation fluid line 740 on a downstream side of the PTO switch valve 745.

The PTO clutch mechanism 140 includes the driving-side member 141 operatively connected to the driving power source 20 through the input shaft 105, a clutch housing 142 supported by the PTO shaft 130 in a relatively non-rotatable manner with respect thereto, and group of frictional plates 143 including group of driving-side frictional plates supported by the driving-side member 141 in a relatively non-rotatable manner with respect thereto and group of driven-side frictional plates supported by the clutch housing 142 in a relatively non-rotatable manner with respect thereto, wherein the group of frictional plates 143 are selectively in a frictional-engaged state or in a released state by operation fluid supplied or discharged through the PTO operation fluid line 740.

A reference numeral 145 in FIG. 2 designates a PTO brake mechanism that actuates in a contradictory manner to the PTO clutch mechanism 140.

The PTO shaft outputting rotational power that has been transmitted thereto through the PTO clutch mechanism 140 is operatively connected to an input part of the mower device 70 through a suitable transmitting member 135 (see FIG. 1).

The main hydraulic motor 50(1) is now explained.

As shown in FIG. 3, the working vehicle 1 according to the present embodiment includes two hydraulic motors 50R(1), 50L(2) arranged on right and left sides, respectively, as the main hydraulic motor 50(1), and also includes two hydraulic motors 50R(2), 50L(2) arranged on right and left sides, respectively, as the sub hydraulic motor 50(2).

Specifically, the two hydraulic motors 50R(1), 50L(1) functioning as the main hydraulic motor 50(1) are fluidly connected in parallel to the main hydraulic pump 40(1) through the pair of main operation fluid lines 600(1).

On the other hand, the two hydraulic motors 50R(2), 50L(2) functioning as the sub hydraulic motor 50(2) are fluidly connected in parallel to the sub hydraulic pump 40(2) through the pair of sub operation fluid lines 600(2).

The four hydraulic motors have the same configurations one another, and each hydraulic motor forms a part of a wheel motor device 200.

In more detail, the working vehicle 1 includes the four wheel motor devices 200 each including the hydraulic motor, and the four wheel motor devices 200 drive the pair of main driving wheels 30(1) and the pair of sub driving wheels 30(2), respectively.

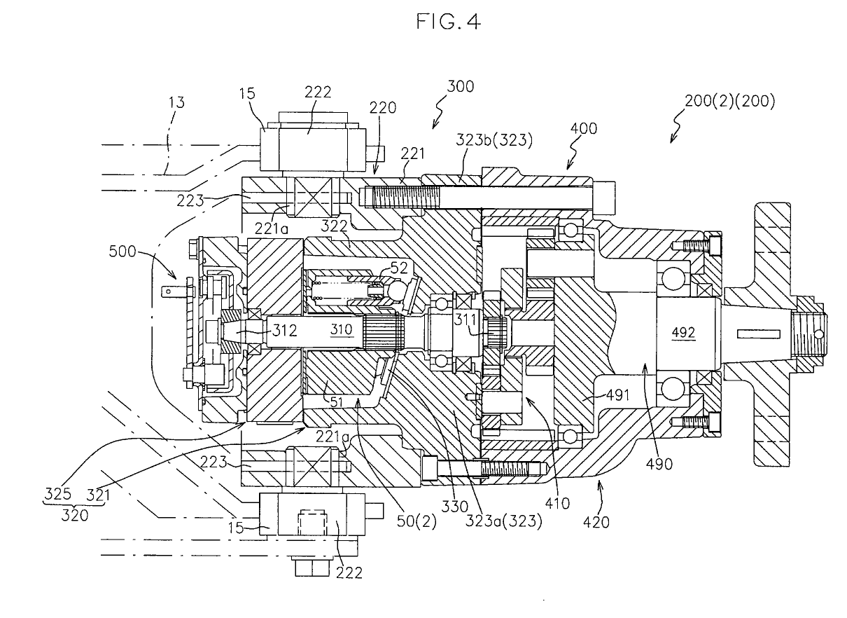

FIG. 4 is a vertical cross-sectional view of the wheel motor device 200 (which may be hereinafter referred to as a sub-driving-wheel wheel motor device 200(2) in some cases) that drives the front wheel functioning as the sub driving wheel 30(2).

As shown in FIGS. 3 and 4, the wheel motor device 200 includes a hydraulic motor unit 300 having the corresponding hydraulic motor 50(1), 50(2), a speed-reduction gear unit 400 having a speed-reduction gear mechanism 410 that reduces rotational speed of rotational power of hydraulic motor 50(1), 50(2), and an outputting member 490 outputting rotational power whose rotational speed has been reduced by the speed-reduction gear mechanism 410 toward the corresponding driving wheel 30(1), 30(2).

The hydraulic motor unit 300 includes the corresponding hydraulic motor 50(1), 50(2), the motor shaft 310 supporting the hydraulic motor 50(1), 50(2) in a relatively non-rotatable manner with respect thereto, and a motor case 320 accommodating the hydraulic motor 50(1), 50(2) and supporting the motor shaft 310 in a rotatable manner around its axis line, as shown in FIGS. 3 and 4.

The motor case 320 includes a hollow motor case main body 321 with an opening that has a size allowing the corresponding hydraulic motor 50(1), 50(2) to pass therethrough, and a motor-side port block 325 detachably connected to the motor case main body 321 so as to close the opening.

In the present embodiment, as shown in FIG. 3, the motor case 320 (the motor-side port block 325) is formed with a pair of motor-side operation fluid channels 660, as shown in FIG. 3.

The motor-side operation fluid channels 660 include a motor-side forward-movement high-pressure fluid channel 660H and a motor-side forward-movement low-pressure fluid channel 660L that have a high pressure and a low pressure, respectively, at the forward movement of the vehicle.

The forward-movement high-pressure fluid channel 660H has a first end fluidly connected to a forward-movement suction side of the corresponding hydraulic motor 50(1), 50(2) and a second end opened to an outer surface to form a motor-side forward-movement high-pressure port 661H.

The forward-movement low-pressure fluid channel 660L has a first end fluidly connected to a forward-movement discharge side of the corresponding hydraulic motor 50(1), 50(2) and a second end opened to the outer surface to form a motor-side forward-movement low-pressure port 661L.

As shown in FIG. 3, the pair of motor-side operation fluid passages 660 of the sub-driving-wheel wheel motor device 200(2) form a part of the pair of sub operation fluid lines 600(2).

Specifically, the pair of sub operation fluid lines 600(2) includes the pair of sub-pump-side operation fluid channels 610(2), the pair of motor-side operation fluid channels 660 of the sub-driving-wheel wheel motor device 200(2), and a pair of sub-driving-wheel operation fluid conduits 670(2) fluidly connecting the pair of sub-pump-side operation fluid channels 610(2) and the pair of motor-side operation fluid channels 660.

The pair of sub-driving-wheel operation fluid conduits 670(2) include a sub-driving-wheel forward-movement high-pressure conduit 670H(2) and a sub-driving-wheel forward-movement low-pressure conduit 670L(2).

The sub-driving-wheel forward-movement high-pressure conduit 670H(2) has a first end fluidly connected to the sub-pump-side forward-movement high-pressure port 611H(2) and a second end that is branched into two portions to fluidly connect the motor-side forward-movement high-pressure ports 661H of the pair of sub-driving-wheel wheel motor devices 200(2), respectively.

Similarly, the sub-driving-wheel forward-movement low-pressure conduit 670L(2) has a first end fluidly connected to the sub-pump-side forward-movement low-pressure port 611L(2) and a second end that is branched into two portions to fluidly connect the motor-side forward-movement low-pressure ports 661L of the pair of sub-driving-wheel wheel motor devices 200(2), respectively.

The pair of motor-side operation fluid channels 660 of the wheel motor device 200 (which may be hereinafter, in some cases, referred to as a main-driving-wheel wheel motor device 200(1)) that drives the rear wheel functioning as the main driving wheel 30(1) form a part of the main operation fluid lines 600(1).

Specifically, the pair of main operation fluid lines 600(1) include the pair of main-pump-side operation fluid channels 610(1), the pair of motor-side operation fluid channels 660 of the main-driving-side wheel motor devices 200(1), and a pair of main-driving-wheel operation fluid conduits 670(1) fluidly connecting the pair of main-pump-side operation fluid channels 610(1) and the pair of motor-side operation fluid channels 660.

The pair of main-driving-wheel operation fluid conduits 670(1) include a main-driving-wheel forward-movement high-pressure conduit 670H(1) and a main-driving-wheel forward-movement low-pressure conduit 670L(1).

The main-driving-wheel forward-movement high-pressure conduit 670H(1) has a first end fluidly connected to the main-pump-side forward-movement high-pressure port 611H(1) and a second end that is branched into two portions to fluidly connect the motor-side forward-movement high-pressure ports 661H of the pair of main-driving-wheel wheel motor devices 200(1), respectively.

Similarly, the main-driving-wheel forward-movement low-pressure conduit 670L(1) has a first end fluidly connected to the main-pump-side forward-movement low-pressure port 611L(1) and a second end that is branched into two portions to fluidly connect the motor-side forward-movement low-pressure ports 661L of the pair of main-driving-wheel wheel motor devices 200(1), respectively.

The motor shaft 310 is supported by the motor case 320 in a rotatable manner around its axis line in a state of having a first end 311, which is positioned closer to the corresponding driving wheel 30(1), 30(2), extended outward, and the first end 311 functions as an output end for outputting rotational power to the corresponding hydraulic motor 50(1), 50(2), as shown in FIG. 4.

In the present embodiment, the motor shaft 310 has a second end, which is positioned opposite from the corresponding driving wheel 30(1), 30(2), extended outward, and the second end 312 functions as a receiving portion to which a brake mechanism 200 attached to the wheel motor device 200 applies a brake force.

Specifically, the wheel motor device 200 includes the brake mechanism 500 in addition to the above components, as shown in FIG. 4.

The brake mechanism 500 is configured so as to apply the brake force to the motor shaft that is positioned on an upstream side of the speed-reduction gear mechanism 410.

The configuration makes it possible to reduce braking capacity that is needed for the brake mechanism 500, thereby miniaturizing the brake mechanism 500.

Although the brake mechanism 500 in the present embodiment is embodied by an internal expanding type, as shown in FIG. 4, it is possible to alternatively employ a different type brake such as a disk-brake type or a band brake type.

The hydraulic motor 50(1), 50(2) includes a motor-side cylinder block 51 supported by the motor shaft 310 in a relatively non-rotatable manner with respect thereto, and plural motor-side pistons 52 accommodated in the motor-side cylinder block 51 in a relatively non-rotatable manner but in a relatively reciprocating manner along the axial direction with respect thereto, as shown in FIG. 4.

As explained above, the hydraulic motors 50(1), 50(2) are of a fixed displacement type.

Therefore, the hydraulic motor unit 300 includes a fixed swash plate 330 for fixing a reciprocating range of the plural motor-side pistons, in addition to the above components.

The speed-reduction gear unit 400 includes the speed-reduction gear mechanism 410, and a gear case 420 detachable connected to the motor case 320 so as to form a gear space for accommodating the speed-reduction gear mechanism 410, as shown in FIGS. 3 and 4.

In the present embodiment, the speed-reduction gear mechanism 410 includes first and second planetary gear mechanisms arranged in series to each other, as shown in FIG. 4.

The output member 490 is configured so as to output rotational power whose rotational speed has been reduced by the speed-reduction gear mechanism 410 toward the corresponding driving wheel 30(1), 30(2).

In the present embodiment, the output member 490 includes a flange portion 491 connected to an output portion of the speed-reduction gear mechanism 410, and an output shaft portion 492 that extends from the flange portion 491 in a direction towards the corresponding driving wheel 30(1), 30(2) and has a free end extended outward.

In the illustrated embodiment, the output shaft portion 492 and the flange portion 491 are integrally formed with each other.

Although the hydraulic motor 50 in the wheel motor device 200 is embodied by an axial piston type in the present embodiment, the present invention is not limited to this embodiment. That is, the hydraulic motor 50 may be embodied by various hydraulic motors such as a radial piston type, a circumscribed gear type, an inscribed gear type and a gerotor type.

In the present embodiment, the wheel motor device 200 is provided with the speed-reduction gear mechanism 410 as previously explained, the speed-reduction gear mechanism 410 could be omitted when a low-speed/high-torque hydraulic motor is utilized as the hydraulic motor, for example.

By the way, due to an inertia force, the main driving wheel 30(1) and the sub driving wheel 30(2) may rotate at a rotational speed higher than a rotational speed at which they are driven by the corresponding hydraulic motor 50(1), 50(2) when the vehicle travels on a downward slope, which causes the corresponding hydraulic motor 50(1), 50(2) to perform a pumping function.

If such pumping function of the hydraulic motor 50(1), 50(2) occurs, one of the hydraulic operation fluid lines that is fluidly connected to the discharge side of the hydraulic motor 50(1), 50(2) has a high pressure in a similar manner to the free wheel phenomenon, which may cause a leakage of operation fluid from the operation fluid lines that is subjected to the higher pressure.

If such a leakage occurs, the fluid is circulated from the other operation fluid line that is subjected to a negative pressure to the one operation fluid line that is subjected to the higher pressure, which facilitates the leakage of the operation fluid from the one operation fluid line that is subjected to the higher pressure and then finally causes amount of operation fluid in the pair of main operation fluid lines 600(1) and the pair of sub operation fluid lines 600(2) to be reduced to an abnormal level, resulting in uncontrollability of the main-driving-wheel HST and the sub-driving-wheel HST.

In order to prevent an occurrence of such a situation, the working vehicle according to the present embodiment includes a motor-side self-suction structure.

In the present embodiment, only the wheel motor device 200 that drives the front wheel (that is, only the sub-driving-wheel wheel motor device 200(2) in the present embodiment, since the front wheel functions as the sub driving wheel in the present embodiment) is provided with the motor-side self-suction structure, as shown in FIG. 3.

The reason is as follows.

Specifically, the HST that drives the driving wheel positioned on a forward side in a traveling direction has a possibility of being in uncontrollability higher than the HST that drives the driving wheel positioned on a rearward side in the traveling direction since one of the main driving wheel 30(1) and the sub driving wheel 30(2) that is positioned on the forward side in the traveling direction is subjected to the inertia force greater than the other of the main driving wheel 30(1) and the sub driving wheel 30(2) that is positioned on the rearward side in the traveling direction when the working vehicle travels on a downward slope. Further, traveling in the forward direction on the downward slope is more often than traveling in the rearward direction on the same. Therefore, only the wheel motor device 200 (only the sub-driving-wheel wheel motor device 200(2) in the present embodiment) that drives the front wheel is provided with the motor-side self-suction structure in order to effectively prevent occurrence of uncontrollability of the HST while preventing cost increase due to provision of the motor-side self-suction structure as much as possible.

The motor-side self-suction structure may be, of course, provided in the wheel motor device that drives the rear wheel, in place of or in addition to the wheel motor device that drives the front wheel, in accordance with necessity and/or specification.

Specifically, as shown in FIG. 3, the motor case 320 in at least one of the pair of wheel motor devices 200 (the pair of sub-driving-wheel wheel motor devices 200(2) in the present embodiment) that drives the front wheels is provided with a motor-side self-suction fluid channel 680 and a motor-side self-suction check valve 685. The motor-side self-suction fluid channel 680 has a first end opened into an inner space of the motor case 320 and a second end fluidly connected to at least one of the pair of motor-side operation fluid channels 660. The motor-side self-suction check valve 685 allows fluid to flow in the motor-side self-suction fluid channel 680 from the motor case 320 to the corresponding motor-side operation fluid channel 660 while preventing the reverse flow.

In the present embodiment, the second end of the motor-side self-suction fluid channel 680 is branched into two fluid channels to fluidly connect to both the pair of motor-side operation fluid channels 660, and the motor-side self-suction check valve 685 is inserted in each of the two fluid channels, as shown in FIG. 3.

In the working vehicle 1 according to the present embodiment, the pair of front wheels are steering wheels that are steered in accordance with an operation on a steering member 62 such as a steering wheel that is disposed in the vicinity of the driver's seat 60, and the pair of rear wheels are non-steering wheels.

Therefore, the wheel motor devices (the sub-driving-wheel wheel motor devices 200(2) in the present embodiment) that drive the front wheels are supported by the vehicle frame 10 in a rotatable manner around a king pin shaft.

In the present embodiment, the hydraulic motor unit 300 in the wheel motor device 200 that drives the steering wheel is of a fixed displacement type in which the capacity of the hydraulic motor 50 is fixed. However, the hydraulic motor unit 300 in the wheel motor device 200 that drives the steering wheel could be of a variable displacement type in which a movable swash plate capable of changing the reciprocating range of the motor-side pistons 52 is utilized in place of the fixed swash plate 330.

In a case where the hydraulic motor unit 300 in the wheel motor device 200 that drives the steering wheel is of a variable displacement type, the capacity of the hydraulic motor may be controlled so as to become small in response to a turning angle of the steering wheel, thereby making a turning radius of the working small without desolating a road surface on which the working travels.

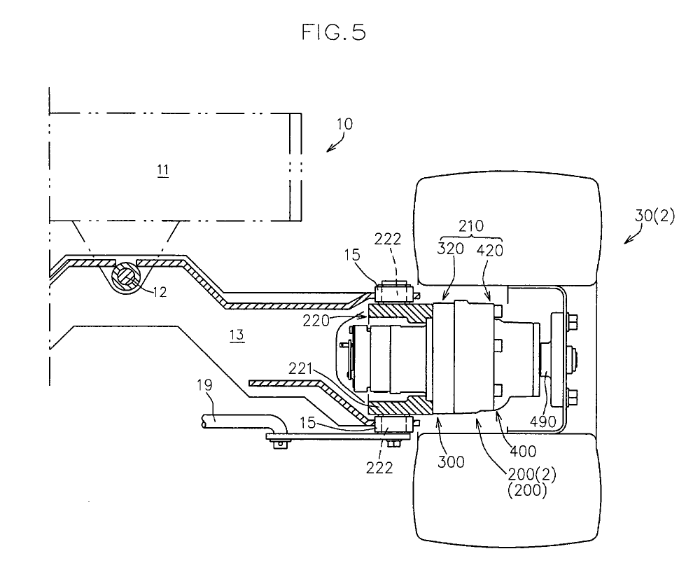

FIG. 5 shows a vertical cross-sectional view of a vicinity of the front wheel functioning as the steering wheel.

As shown in FIGS. 4 and 5, the wheel motor device 200(2) that drives the steering wheel is provided with an attachment bracket 220 for connecting a wheel motor housing 210 formed by the motor case 320 and the gear case 420 to the vehicle frame 10 in a rotatable manner around the king pin shaft.

As shown in FIGS. 4 and 5, the attachment bracket 220 includes a main body portion 221 connected to the wheel motor housing 210, and a pair of pivotal shaft portions 222 that extend in upper and lower directions from the main body portion 221 to form the king pin shaft.

The vehicle frame 10 is provided with a pair of upper and lower bearing portions 15 in which the pair of pivotal shaft portions 222 are inserted in a rotatable manner around the respective axis line.

Specifically, as shown in FIGS. 1, 4 and 5, the vehicle frame 10 includes a main frame 11 supporting the driving power source 20, the driver's seat 60 or the like, and a steering-wheel axle frame 13 (a front-wheel axle frame in the present embodiment) connected to the main frame 11 in a rotatable manner around a rotation shaft 12 that extends in the vehicle lengthwise direction.

The steering-wheel axle frame 13 is provided with the pair of bearing portions 15 at both right and left sides thereof.

The pair of right and left wheel motor devices 200 (the pair of right and left sub-driving-wheel wheel motor devices 200(2) in the present embodiment) that respectively drives the pair of driving wheels are connected to each other in an interlocking manner through a tie rod 19 so as to rotate around the respective king pin shafts in conjunction with each other according to the operation of the steering member 62.

In the present embodiment, the pair of pivotal shaft portions 222 are detachably connected to the main body portion 221.

Specifically, the main body portion 221 is formed with a pair of bearing holes 221a in which the pair of pivotal shaft portions 222 are inserted respectively, as shown in FIG. 4. The pivotal shaft portion 222 is fixed to the main body portion 221 by a retaining pin 223 in a state of being inserted in the corresponding bearing hole 221a.

The thus configured wheel motor device 200(2) is supported by the steering-wheel axle frame 13 in a rotatable manner around the pivotal shaft portion 222 by inserting the pair of pivotal shaft portions 222 into the pair of bearing portions 15 and the pair of bearing holes 221a from outside in the upper and lower direction with the main body portion 221 of the attachment bracket 220 being positioned between the pair of bearing portions 15 and then connecting the pivotal shaft portions 222 and the main body portion 221 with the retaining pins 223.

In the present embodiment, the main body portion 221 is connected to the wheel motor housing 210 formed by the motor case 320 and the gear case 420 with utilizing a flange portion 323b provided in the motor case main body 321.

Specifically, as shown in FIG. 4, the motor case main body 321 includes a hollow circumferential wall portion 322 surrounding the hydraulic motor 50(2) and an end wall portion 323 closing one end of the circumferential wall portion 322 that is positioned closer to the corresponding driving wheel 30(2), wherein the other end of the circumferential wall portion 322 that is opposite from the corresponding driving wheel 30(2) is provide with the opening having a size that allows the corresponding hydraulic motor 50(2) to pass therethrough.

The opening is liquid-tightly closed by the motor-side port block 325, as explained above.

The end wall portion 323 includes a center portion 323a corresponding to the circumferential wall portion 322 and the flange portion 323b extending outward in a radial direction from the center portion 323a.

The main body portion 221 of the attachment bracket 220 has such a hollow shape as to surround the circumferential wall portion 322 of the motor case main body 321 and the motor-side port block 325, as shown in FIG. 4. The main body portion 221 is detachably connected to the wheel motor housing 210 through a tightening member such as a bolt in a state where an end of the main body portion 221 that is positioned closer to the corresponding driving wheel 30(2) is brought into contact with the flange portion 323b.

The wheel motor device 200 (the main-driving-wheel wheel motor device 200(1) in the present embodiment) that drives the non-steering wheel is directly or indirectly supported by the main frame 11 in a fixed manner.

In the working vehicle 1 according to the present embodiment, the front wheel functions as the steering wheel. However, the present invention is obviously not limited to the embodiment. That is, the present invention could be applied to a working vehicle configured so that the front wheel is the non-steering wheel and the rear wheel is the steering wheel, or a working vehicle configured so that both front and rear wheels are the steering wheels.

The working vehicle 1 further includes a front/rear differential-lock switch valve 800 that fluidly connects the forward-movement high-pressure lines of the pair of main operation fluid lines 600(1) and the pair of sub operation fluid lines 600(2) and also fluidly connects the forward-movement low-pressure lines of the pair of main operation fluid lines 600(1) and the pair of sub operation fluid lines 600(2), as shown in FIG. 3.

The front/rear differential-lock switch valve 800 is configured so as to take a throttling fluid-connection state of fluidly connecting the corresponding lines in a state where a throttle is interposed therebetween and a full fluid-connection state of fluidly connecting the corresponding lines in a state where the throttle is not interposed therebetween.

In the present embodiment, as shown in FIG. 3, the front/rear differential-lock switch valve 800 includes a high-pressure-side front/rear differential-lock switch valve 800H interposed between the forward-movement high-pressure lines 600H(1), 600H(2) of the pair of main operation fluid lines 600(1) and the pair of sub operation fluid lines 600(2), and a low-pressure-side front/rear differential-lock switch valve 800L interposed between the forward-movement low-pressure lines 600L(1), 600L(2) of the pair of main operation fluid lines 600(1) and the pair of sub operation fluid lines 600(2).

Specifically, as shown in FIG. 3, the working vehicle 1 includes a high-pressure-side communication line 810H fluidly connecting the forward-movement high-pressure lines 600H(1), 600H(2) of the pair of main operation fluid lines 600(1) and the pair of sub operation fluid lines 600(2), a low-pressure-side communication line 810L fluidly connecting the forward-movement low-pressure lines 600L(1), 600L(2) of the pair of main operation fluid lines 600(1) and the pair of sub operation fluid lines 600(2), the high-pressure-side front/rear differential-lock switch valve 800H that is interposed in the high-pressure-side communication line 810H and is capable of selectively taking a throttling-communication state of communicating the high-pressure-side communication line 810H with throttling the same and a full-communication state of communicating the high-pressure-side communication line 810H without throttling the same, and the low-pressure-side front/rear differential-lock switch valve 800L that is interposed in the low-pressure-side communication line 810L and is capable of selectively taking a throttling-communication state of communicating the low-pressure-side communication line 810L with throttling the same and a full-communication state of communicating the low-pressure-side communication line 810L without throttling the same.

The high-pressure-side front/rear differential-lock switch valve 800H and the low-pressure-side front/rear differential-lock switch valve 800L are configured to change respective communication states in a synchronized manner to each other.

In the present embodiment, as shown in FIG. 3, each of the high-pressure-side front/rear differential-lock switch valve 800H and the low-pressure-side front/rear differential-lock switch valve 800L is embodied by a solenoid valve including a valve main body capable of taking a throttling-communication position of fluidly communicating the corresponding communication line 810H, 810L with a throttle interposed therein and a full-communication position of fluidly communicating the corresponding communication line 810H, 810L without the throttle.

The valve main bodies of the high-pressure-side front/rear differential-lock switch valve 800H and the low-pressure-side front/rear differential-lock switch valve 800L are position-controlled in a synchronized manner to each other based on a control signal from a control unit 90 in response to an operation on a first switch operating member 65 (see FIG. 3) arranged in the vicinity of the driver's seat 60.

As explained above, in the working vehicle according to the present embodiment, the forward-movement high-pressure lines 600H(1), 600H(2) of the pair of main operation fluid lines 600(1) and the pair of sub operation fluid lines 600(2) are fluidly connected to each other through the front/rear differential-lock switch valve 800 capable of selectively taking the throttling fluid-connection state or the full fluid-connection state, and the forward-movement low-pressure lines 600L(1), 600L(2) of the pair of main operation fluid lines 600(1) and the pair of sub operation fluid lines 600(2) are also fluidly connected to each other through the front/rear differential-lock switch valve 800. The thus configured the working vehicle makes it possible to select a state capable of realizing a front-rear hydraulic differential function while preventing transmission efficiency from being worsened and a state capable of supplying a part of operation fluid, which has been discharged from the hydraulic pump 40, to one hydraulic motor 50(1), 50(2) driving one of the front and rear driving wheels that is subjected to a load higher than the other driving wheel even if a difference in rotation load between the front and rear driving wheels becomes extremely great.

Specifically, there has been proposed a conventional hydraulic four-wheel-drive working vehicle including a pair of first driving wheels and a pair of second driving wheels arranged on one side and the other side in the vehicle lengthwise direction, respectively, a first hydraulic motor that outputs rotational power for driving the first driving wheels, a second hydraulic motor that outputs rotational power for driving the second driving wheels, first and second hydraulic pumps operatively driven by a driving power source, a pair of first operation fluid lines that fluidly connects the first hydraulic pump and the first hydraulic motor in such a manner that they form a first HST, and a pair of second operation fluid lines that fluidly connects the second hydraulic pump and the second hydraulic motor in such a manner that they form a second HST, wherein a forward-movement high-pressure line of the pair of first operation fluid lines and a forward-movement high-pressure line of the pair of second operation fluid lines are fluidly connected to each other through a high-pressure-side communicating line in which a throttle valve is interposed, and a forward-movement low-pressure line of the pair of first operation fluid lines and a forward-movement low-pressure line of the pair of second operation fluid lines are fluidly connected to each other through a low-pressure-side communicating line in which a throttle valve is interposed.

The high-pressure-side communicating line that fluidly connects forward-movement high-pressure lines of the pair of first operation fluid lines and the pair of second operation fluid lines and the low-pressure-side communicating line that fluidly connects the forward-movement low-pressure lines of the pair of first operation fluid lines and the pair of second operation fluid lines makes it possible to automatically distribute and supply a part of operation fluid, which has been discharged from one of the first and second hydraulic pumps, into the hydraulic motor that forms the HST in cooperation with the other of the first and second hydraulic pumps in accordance with a difference in turning radius between the first and second driving wheels when the vehicle makes a turn so that the conventional working vehicle obtain the front-rear hydraulic differential function (hydraulic center differential function). Further, the throttle valves interposed in the communicating lines make it possible to prevent all of operation fluid, which has been discharged from the first and second hydraulic pumps, from flowing in a concentrated manner into one of the first and second hydraulic motors that drives one of the first and second driving wheels even if the one driving wheel falls into a depression, a mud area or the like so that the rotation load of the one driving wheel becomes extremely small, whereby the conventional working vehicle obtains the differential-lock function.

However, in the conventional working vehicle, the forward-movement high-pressure lines of the pair of first operation fluid lines and the pair of second operation fluid lines are connected to each other in a state where the throttle valve is constantly interposed therebetween, and the forward-movement low-pressure lines of the first and second operation fluid lines are fluidly connected to each other in a state where the throttle valve is constantly interposed therebetween. That is, the conventional working vehicle could achieve the hydraulic center differential function only in a state of being subjected to load due to the throttle valves when the vehicle travels. Accordingly, in the conventional working vehicle applies, the hydraulic pump is driven with load being applied thereon and the hydraulic motor could not exercise its intrinsic performance, which leads to deterioration of transmission efficiency.

On the other hand, the working vehicle 1 according to the present embodiment could realize the front-rear hydraulic differential function without involving loss of the transmission efficiency by having the front/rear differential-lock switch valve 800 at the full fluid-connection state at the time of a normal traveling state in which the working vehicle travels on a normal road surface, and could also effectively prevent incapability of traveling while realizing the hydraulic center differential function by having the front/rear differential-lock switch valve 800 at the throttling fluid-connection state at the time when the road surface is slippery or one of the front and rear wheels falls into a depression, a mud area or the like.

Further, the working vehicle 1 according to the present embodiment includes a 2-wheel-drive/4-wheel-drive switch valve 850, as shown in FIG. 3. The 2-wheel-drive/4-wheel-drive switch valve 850 is interposed in the pair of sub operation fluid lines 600(2) so as to divide the pair of sub operation fluid lines 600(2) into pump-side lines 601(2) and motor-side lines 602(2). The 2-wheel-drive/4-wheel-drive switch valve 850 is positioned on a side closer to the sub hydraulic motor 50(2) than a connecting point 605 at which the pair of sub operation fluid lines 600(1) are fluidly connected to the pair of main operation fluid lines 600(1) through the front/rear differential-lock switch valve 800, and could selectively take an open state or a closed state.

The 2-wheel-drive/4-wheel-drive switch valve 850 fluidly connects the corresponding pump-side lines 601(1) and the motor-side lines 602(2) of the pair of sub operation fluid lines 600(2) when it is at the open state, and closes the pump-side lines 601(2) and fluidly connects one motor-side line 602(2) and the other motor-side line 602(2) of the pair of sub operation fluid lines 600(2) when it is at the closed state.

The provision of the 2-wheel-drive/4-wheel-drive switch valve 850 makes it possible to properly select a 4-wheel-drive state in which both the main driving wheels 30(1) and the sub driving wheels 30(2) are driven and a 2-wheel-drive state in which only the main driving wheels 30(1) are driven, while allowing the hydraulic motors 50(2) of the sub-driving-wheel wheel motor devices 200(2) to be driven and rotated in accordance with rotation of the sub driving wheels 30(2).

The 2-wheel-drive state could cause the working vehicle to travel at high speed since all the operation fluid, which has been discharged from the main and sub hydraulic pumps 40(1), 40(2), are supplied to the main hydraulic motors 50(1).

In the present embodiment, the 2-wheel-drive/4-wheel-drive switch valve 850 is embodied by a solenoid valve including a valve main body, which selectively take an open position that fluidly connects the pump-side line 601(2) and the motor-side line 602(2) of each of the pair of sub operation fluid lines 600(2) and a closed position that fluidly closes the pump-side lines 601(2) and fluidly connect the motor-side lines 602(2) of the pair of sub operation fluid lines 600(2) to each other.

The valve main body of the 2-wheel-drive/4-wheel-drive switch valve 850 is position-controlled based on a control signal from the control unit 90 in response to an operation on a second switch operating member 66 (see FIG. 3) arranged in the vicinity of the driver's seat 60.

Preferably, the front/rear differential-lock switch valve 800 is automatically set at the full fluid-connection state when the 2-wheel-drive/4-wheel-drive switch valve 850 is set at the closed state.

The preferable configuration makes it possible to prevent deterioration of transmission efficiency in the 2-wheel-drive state.

Specifically, in the 2-wheel-drive state with the 2-wheel-drive/4-wheel-drive switch valve 850 being set at the closed state, all the operation fluid, which has been discharged from the sub hydraulic pump 40(2), are supplied into the forward-movement high-pressure line 600H(1) of the pair of main operation fluid lines 300(1) through the high-pressure-side communication line 810H.

Accordingly, if the front/rear differential-lock switch valve 800 is set at the throttling fluid-connection state when the 2-wheel-drive/4-wheel-drive switch valve is set at the closed state, all the operation fluid, which has been discharged from the sub hydraulic pump 40(2), are supplied to the forward-movement high-pressure line 600H(1) through the throttle, which leads to incapacity to bring out the intrinsic performance of the sub hydraulic pump 40(2) and the main hydraulic motor 50(1), resulting in worsened transmission efficiency.

On the other hand, according to the configuration in which the front/rear differential-lock switch valve 800 is automatically sent at the full fluid-connection state in response to the closed state of the 2-wheel-drive/4-wheel-drive switch valve 850, the operation fluid, which has been discharged from the sub hydraulic pump 40(2), could be smoothly supplied to the forward-movement high-pressure line 600H(1) of the pair of main operation fluid lines 600(1) through the high-pressure-side communication line 810H, as explained above, whereby improved transmission efficiency could be realized.

Preferably, the front/rear differential-lock switch valve 800 and the 2-wheel-drive/4-wheel-drive switch valve 850 may be mounted in a single valve block 870, as shown in FIG. 3.

The valve block 870 is arranged at a desired position of the vehicle frame 10 in a state of being interposed in the pair of main-driving-wheel operation fluid conduits 670(1) and the pair of sub-driving-wheel operation fluid conduits 670(2).

It is possible to enhance piping workability of the working vehicle 1 by arranging the front/rear differential-lock switch valve 800 and the 2-wheel-drive/4-wheel-drive switch valve 850 in the single valve block 870 in a concentrated manner, as described above.

Although both the front/rear differential-lock switch valve 800 and the 2-wheel-drive/4-wheel-drive switch valve 850 are embodied by the solenoid valves in the present embodiment, the present invention is not limited to the embodiment, of course.

For example, it is possible to operatively connect the first switch operating member 65, the high-pressure-side front/rear differential-lock switch valve 800H and the low-pressure-side front/rear differential-lock switch valve 800L through a mechanical link mechanism so that the high-pressure-side front/rear differential-lock switch valve 800H and the low-pressure-side front/rear differential-lock switch valve 800L are controlled in a synchronized manner to each other in accordance with an operation on the first switch operating member 65.

Further, it is possible to operatively connect the second switch operating member 66 and the 2-wheel-drive/4-wheel-drive switch valve 850 through a mechanical link mechanism so that the 2-wheel-drive/4-wheel-drive switch valve 850 is controlled in accordance with an operation on the second switch operating member 66.

Furthermore, although the high-pressure-side front/rear differential-lock switch valve 800H and the low-pressure-side front/rear differential-lock switch valve 800L are embodied by the solenoid valves and capable of being position-controlled independently to each other in the present embodiment, as shown in FIG. 3, the present invention is not limited to the embodiment.

In place of the configuration, it is possible to employ a configuration in which the high-pressure-side front/rear differential-lock switch valve 800H and the low-pressure-side front/rear differential-lock switch valve 800L are operatively and mechanically connected to each other and both the switch valves are integrally position-controlled by a single electric actuator. The modified configuration could be achieved, for example, by operatively and mechanically connected both the switch valves 800H, 800L to each other and having only one of switch valves 800H, 800L embodied by a solenoid valve.

### Second Embodiment

Another embodiment of the hydraulic four-wheel-drive working vehicle according to the present invention will now be described with reference to the accompanying drawing.

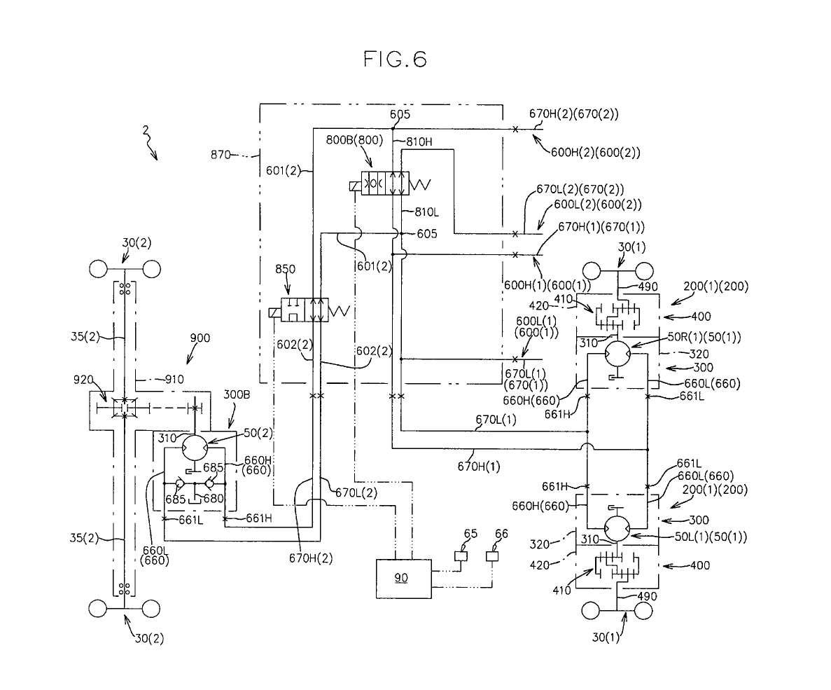

FIG. 6 is a partial hydraulic circuit diagram of a hydraulic four-wheel-drive working vehicle 2 according to the present embodiment, and corresponds to FIG. 3 in the first embodiment.

In the figure, the same components as those in the first embodiment are denoted by the same reference characters, and detailed description thereof will be omitted.

In the working vehicle 1 according to the first embodiment, the pair of main driving wheels 30(1) and the pair of sub driving wheels 30(2) are driven by the dedicated wheel motor devices 200, respectively.

On the other hand, in the working vehicle 2 according to the present embodiment, the pair of main driving wheels 30(1) are driven by the dedicated wheel motor devices 200, but the pair of sub driving wheels 30(2) are driven by rotational power, which is differentially transmitted by a mechanical differential gear mechanism 920 receiving a rotational power from a single sub hydraulic motor 50(2).

Specifically, the working vehicle 2 includes a single axle device 900 in place of the pair of sub-driving-wheel wheel motor devices 200(2) with the working vehicle 1 as a reference.

As shown in FIG. 6, the axle device 900 includes the single hydraulic motor 50(2) fluidly connected to the sub hydraulic pump 40(2) through the pair of sub operation fluid lines 600(2), a pair of sub-driving-wheel axles 35(2) connected to the pair of sub driving wheels 30(2), respectively, the mechanical differential gear mechanism 920 that operatively inputs rotational power from the sub hydraulic motor 50(2) and differentially transmits the same to the pair of sub-driving-wheel axles 35(2), and an axle housing 910 accommodating the differential gear mechanism 920 and the pair of sub-driving-wheel axles 35(2).

The thus configured working vehicle 2 could achieve the same effect as the first embodiment.

Although it is omitted to show in the figure, an outer end of the sub-driving-wheel axle 35(2) and the sub driving wheel 30(2) are connected to each other through a universal joint so that the sub driving wheel 30(2) is capable of being steered.

In the present embodiment, the sub hydraulic motor 50(2) is a part of components forming a hydraulic motor unit 300B, and the hydraulic motor unit 300B is connected to the axle housing 910.

The hydraulic motor unit 300B includes the self-suction structure, as in the hydraulic motor unit 300 of the sub-driving-wheel wheel motor device 200(2) in the working vehicle 1 according to the first embodiment.

Further, the working vehicle 2 according to the present embodiment includes a single switch valve 800B of four-ports/two-positions type as the front/rear differential-lock switch valve 800, as shown in FIG. 6.

That is, the working vehicle includes the single switch valve 800B of four-ports/two-positions type, in place of the two switch valves of two-ports/two-positions type (the high-pressure-side front/rear differential-lock switch valve 800H and the low-pressure-side front/rear differential-lock switch valve 800L) in the first embodiment.

The single switch valve 800B is capable of taking a throttling-communication state of fluidly connecting the forward-movement high-pressure lines 600H(1), 600H(2) to each other of the pair of main operation fluid lines 600(1) and the pair of sub operation fluid lines 600(2) in a state where a throttle is interposed therebetween and fluidly connecting the forward-movement low-pressure lines 600L(1), 600L(2) to each other of the same in a state where a throttle valve is interposed therebetween, and a full-communication state of fluidly connecting the corresponding lines to each other in a state where the throttle is not interposed therebetween.

It is, of course, possible to provide the single switch valve 800 of four-ports/2-positions type in the working vehicle 1 according to the first embodiment, in place of the two switch valves of two-ports/two-positions type (the high-pressure-side front/rear differential-lock switch valve 800H and the low-pressure-side front/rear differential-lock switch valve 800L)

Although the working vehicle 2 according to the present embodiment is configured so that the pair of sub driving wheels 30(2) are differentially driven by the single hydraulic motor 50(2) and the differential gear mechanism 920 and the pair of main driving wheels 30(1) are driven by the pair of main-driving-wheel wheel motor devices 200(1), the present invention is not limited to the embodiment.

Specifically, it is possible to configure so that the pair of main driving wheels 30(1) are differentially driven by a single hydraulic motor 20(1) and the differential gear mechanism 920 and the pair of sub driving wheels 30(2) are driven by the pair of sub-driving-wheel wheel motor devices 200(2), respectively, or also possible to configure so that the pair of main driving wheels 30(1) as well as the pair of sub driving wheels 30(2) are driven by the corresponding axle devices 900 including the single hydraulic motor and the differential gear mechanism.

Although the wheel motor device 200 that driving the non-steering wheel is configured so that the hydraulic motor 50, the speed-reduction gear mechanism 410 embodied by the planetary gear mechanism and the outputting member 490 are arrange along the vehicle widthwise direction one another in the above explained embodiments, the present invention is not limited to the configuration.

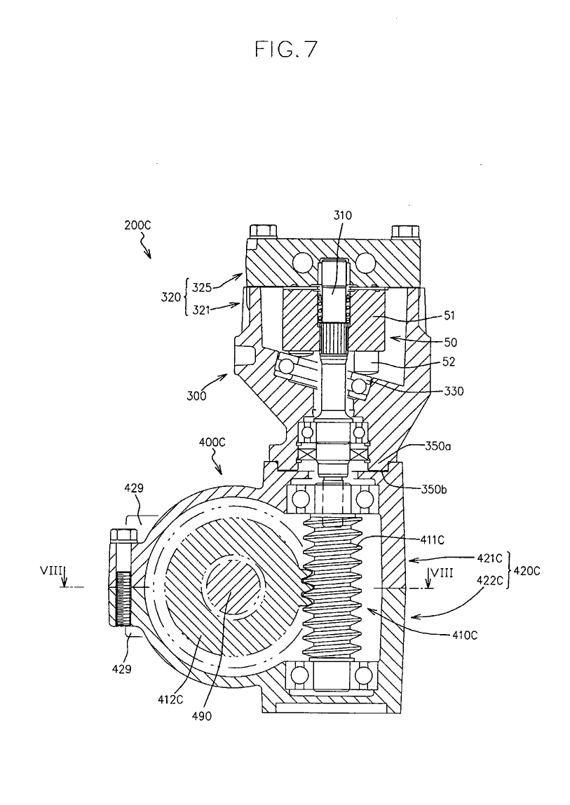

FIG. 7 is a vertical cross-sectional side view of a wheel motor device according to a first modified example.

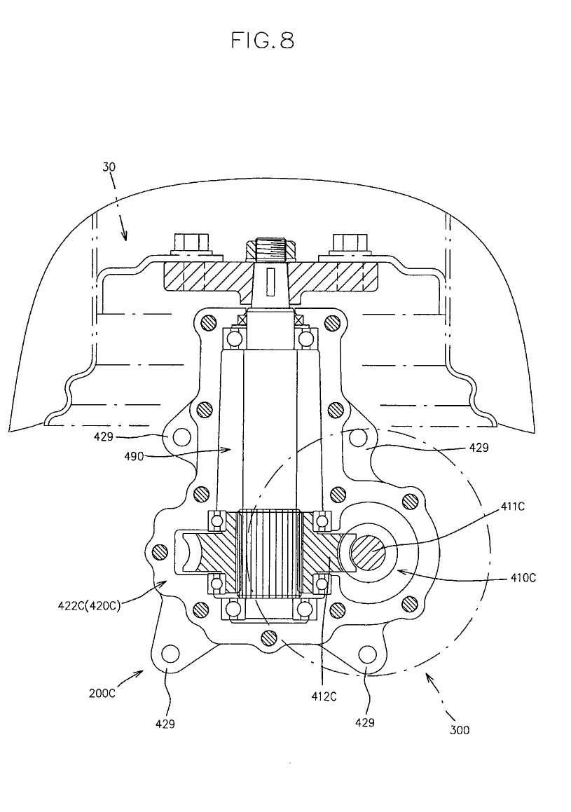

FIG. 8 is a horizontal cross-sectional plan view taken along line VIII-VIII of FIG. 7.

In the figures, the same components as those in the above embodiments are denoted by the same reference characters, and detailed description thereof will be omitted.

In the wheel motor device 200, the hydraulic motor 50 is arranged so as to have a rotational axis along the vehicle widthwise direction, and the speed-reduction gear mechanism 410 embodied by the planetary gear mechanism is arranged between the hydraulic motor 50 and the outputting member 490 with respect to the vehicle widthwise direction.

On the other hand, in the wheel motor device 200C, the hydraulic motor 50 is arranged so as to have the rotational axis orthogonal to a rotational axis of the outputting member 490, and a worm type speed-reduction gear mechanism 410C is arranged between the hydraulic motor 50 and the outputting member 490, as shown in FIGS. 7 and 8.

Specifically, the wheel motor device 200C includes the hydraulic motor unit 300 including the hydraulic motor 50, a speed-reduction gear unit 400C including the worm type speed-reduction gear mechanism 410C, and the outputting member 490, as shown in FIGS. 7 and 8.

The speed-reduction gear unit 400C includes the speed-reduction gear mechanism 410C and a gear case 420C accommodating the speed-reduction gear mechanism 410C.

The speed-reduction gear mechanism 410C includes a worm wheel 412C supported by the outputting member 490 in a relatively non-rotatable manner with respect thereto, and a worm shaft 411C arranged orthogonal to the rotational axis of the outputting member 490 so as to engage with the worm wheel 412C, as shown in FIGS. 7 and 8.

Preferably, a worm gear of the worm shaft 411C has such a lead angle as to allow the worm shaft 411c to be rotated around its axis line in response to the rotation of the worm wheel 412C.

The preferable configuration makes it possible to prevent the worm shaft 411C from locking the driven rotation of the corresponding driving wheel 30 at the time when the wheel motor device 200C is in a non-driving state as in the case of forcibly towing the working vehicle.

The gear case 420C is connected to the motor case 320 in such a manner as that the worm shaft 411C could be operatively connected to the motor shaft 310 while accommodating the worm wheel 412C and supporting the worm shaft 411C in a rotatable manner around its axis line in a state where the worm shaft 411C is orthogonal to the rotational axis of the outputting member 490.

Specifically, the motor case 320 is connected to the gear case 420C so that the motor shaft 310 is connected to the worm shaft in a relatively non-rotatable manner around its axis line in a state where the motor shaft 30 extends orthogonal to the rotational axis of the outputting member 490.

The thus configured wheel motor device 200C makes it possible to secure a larger free space in a center in the vehicle widthwise direction, in comparison with the wheel motor device 200 in which the hydraulic motor unit 300, the speed-reduction gear unit 400 and the outputting member 490 are arranged along the vehicle widthwise direction.

In the wheel motor device 200C according to the first modified example, the worm shaft 411C is along the substantially vertical direction, and the hydraulic motor unit 300 is connected to an upper surface of the speed-reduction gear unit 400C in such a manner as that the motor shaft 310 is connected to the worm shaft 411C in a relatively non-rotatable manner around its axis line in a state of being positioned coaxially with the worm shaft 411C, as shown in FIGS. 7 and 8.

Various modifications could be made as long as the worm shaft is orthogonal to the rotational axis of the outputting member 490.

For example, it is possible to arrange the worm shaft so as to be along the vehicle lengthwise direction.

In the case, the hydraulic motor unit is connected to a front surface or a rear surface of the speed-reduction gear unit 400C in such a manner as that the motor shaft 310 is connected to the worm shaft 411C in a relatively non-rotatable manner around its axis line in a state of being positioned coaxially with the worm shaft 411C.

Preferably, the motor case 320 and the gear case 420C are detachably connected to each other in a state of being brought into contact to each other through a concavo-convex engagement.

Specifically, as shown in FIG. 7, an opposing surface of the motor case 320 that faces the gear case 420C is formed with one of a concave portion 350b and a convex portion 350a, and an opposing surface of the gear case 420C that faces the motor case 320 is formed with the other of the concave portion 350b and the convex portion 350a.

The preferable configuration makes it possible to enhance workability in connecting the motor case 320 and the gear case 420C.

More preferably, the motor case 320 and the gear case 420C are configured so as to be connected to each other at different positions around the axis line of the motor shaft 310.

The preferable configuration makes it possible to easily change directions of the motor-side forward-movement high-pressure port 661H and the motor-side forward-movement low-pressure port 661L in accordance with the specification of the working vehicle.

In the first modified example, the gear case 420C includes first and second gear cases 421C, 422C that have the substantially same configuration to each other and are connected to each other in a detachable manner in an upper and lower direction, as shown in FIG. 7.

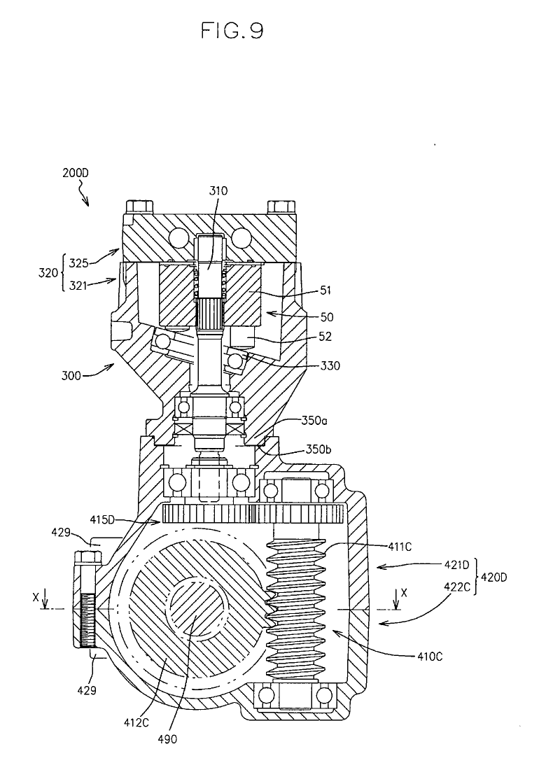

FIG. 9 is a vertical cross-sectional side view of a wheel motor device 200D according to a second modified example.

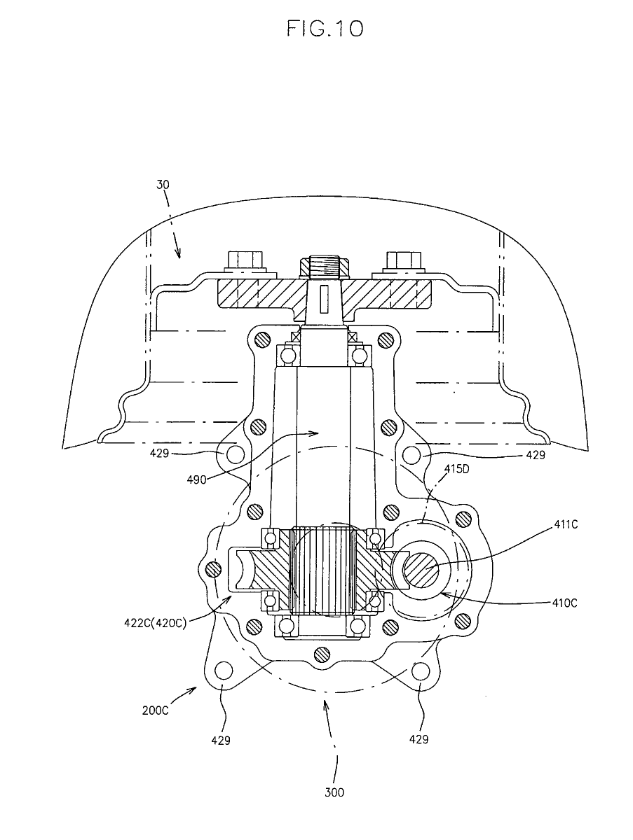

FIG. 10 is a horizontal cross-sectional plan view taken along line X-X of FIG. 9.

In the figures, the same components as those in the above embodiments and the first modified example are denoted by the same reference characters, and detailed description thereof will be omitted.

In the wheel motor device 200C according to the first modified example, the motor shaft 310 is connected to the worm shaft 411C in a relatively non-rotatable manner around the axis line with respect thereto in a state of being positioned coaxially with the same, as described above.

On the other hand, in the wheel motor device 200D according to the second modified example, the motor shaft 310 is connected to the worm shaft 411C in a relatively non-rotatable manner around the axis line in a state of being displaced in a direction towards the outputting member 490 from the worm shaft 411C.

Specifically, the wheel motor device 200D according to the second modified example further includes a transmission gear train 415D operatively connecting the motor shaft 310, which is displaced in the direction towards the outputting member 490 from the worm shaft 411C, to the worm shaft 411C, in comparison with the wheel motor device 200C according to the first modified example.

The wheel motor device according to the second example makes it possible to realize miniaturization of the wheel motor device 200D in a direction orthogonal to both the axis lines of the outputting member 490 and the worm shaft 411C (in the vehicle lengthwise direction in the illustrated example in which the worm shaft 411C is along the substantially vertical direction) while securing a larger space in the center in the vehicle widthwise direction.

Preferably, the transmission gear train 415D is configured so as to allow the motor shaft 310C to be operatively connected to the worm shaft 411C in a state where the motor shaft 310C is overlapped with the outputting member 490 as viewed from the above, as shown in FIGS. 9 and 10.

In the wheel motor device 200D according to the second modified example, the first gear case 421C is replaced with a first gear case 421D capable of accommodating the transmission gear train 415D.

Each of the gear case 420C and the gear case 420D of the wheel motor devices 200C, 200D according to the first and second modified examples is formed with frame attachment bosses 429, and the each gear case 420C, 420D is directly or indirectly fixed to the main frame 11 through the frame attachment bosses 429.

1. A hydraulic four-wheel-drive working vehicle comprising main and sub driving wheels arranged on one and the other sides in a vehicle lengthwise direction, a main hydraulic motor outputting rotational power for driving the main driving wheel, a sub hydraulic motor outputting rotational power for driving the sub driving wheel, one or plural hydraulic pump operatively driven by a driving power source, a pair of main operation fluid lines fluidly connecting the hydraulic pump and the main hydraulic motor in such a manner that they form a main-driving-wheel HST, and a pair of sub operation fluid lines fluidly connecting the hydraulic pump and the sub hydraulic motor in such a manner that they form a sub-driving-wheel HST, the pair of sub operation fluid lines being independent from the pair of main operation fluid lines, the hydraulic four-wheel-drive working vehicle further comprising
a front/rear differential-lock switch valve that fluidly connects forward-movement high-pressure lines of the pair of main operation fluid lines and the pair of sub operation fluid lines and also fluidly connects the forward-movement low-pressure lines of the pair of main operation fluid lines and the pair of sub operation fluid lines,
wherein the front/rear differential-lock switch valve is configured so as to take a throttling fluid-connection state of fluidly connecting the corresponding lines in a state where a throttle is interposed therebetween and a full fluid-connection state of fluidly connecting the corresponding lines in a state where the throttle is not interposed therebetween.

2. The hydraulic four-wheel-drive working vehicle according to claim 1, further comprising,
a 2-wheel-drive/4-wheel-drive switch valve interposed in the pair of sub operation fluid lines so as to divide the pair of sub operation fluid lines into pump-side lines and motor-side lines, the 2-wheel-drive/4-wheel-drive switch valve being positioned on a side closer to the sub hydraulic motor than a connecting point at which the pair of sub operation fluid lines are fluidly connected to the pair of main operation fluid lines through the front/rear differential-lock switch valve, and capable of selectively taking an open state or a closed state,
wherein the 2-wheel-drive/4-wheel-drive switch valve fluidly connects the corresponding pump-side lines and the motor-side lines of the pair of sub operation fluid lines at the open state, and closes the pump-side lines and fluidly connects one motor-side line and the other motor-side line of the pair of sub operation fluid lines at the closed state.

3. The hydraulic four-wheel-drive working vehicle according to claim 2, wherein the front/rear differential-lock switch valve is set at the full fluid-connection state at the time when the 2-wheel-drive/4-wheel-drive switch valve is set at the closed state.
